(19) United States
(12) Patent Application Publication
(10) Pub. No.: US 2007/0091405 A1
(43) Pub. Date: Apr. 26, 2007

(54) LIGHT SCANNING DEVICE AND SCANNING OPTICAL SYSTEM

(75) Inventor: Shohei MATSUOKA, Tokyo (JP)

Correspondence Address: GREENBLUM & BERNSTEIN, P.L.C., 1950 ROLAND CLARKE PLACE, RESTON, VA, 20191, US

(73) Assignee: PENTAX CORPORATION, Tokyo (JP)

(21) Appl. No.: 11/550,058

(22) Filed: Oct. 17, 2006

(30) Foreign Application Priority Data
Oct. 19, 2005 (JP) 2005/304704
Nov. 25, 2005 (JP) 2005/340873

(51) Int. Cl. G02B 26/08

(52) U.S. Cl. 359/205

(57) ABSTRACT

A light scanning device includes a light source configured to emit a laser beam, a deflector configured to deflect and scan the laser beam emitted from the light source in a main scanning direction and an image forming optical system configured to converge the light beam deflected by the deflector as a spot scanning in the main scanning direction on a scanned object surface. The image forming optical system is configured such that at least part of ghost light caused inside the image forming optical system is converged within a predetermined range in the main scanning direction regardless of an incident angle with which the laser beam deflected by the deflector is incident on the image forming optical system, and that the at least part of ghost light is separated from drawing light for forming an image in an auxiliary scanning direction which is perpendicular to the main scanning direction.

### BACKGROUND OF THE INVENTION

The present invention relates to a light scanning device and a scanning optical system incorporated in a laser printer or the like that are configured to scan a laser beam on a scanned object surface, in particular, a light scanning device and a scanning optical system configured to prevent ghost light from reaching the scanned object surface.

A light scanning device incorporated in a laser printer or the like is configured such that a laser beam emitted from a light source is reflected and deflected by a deflector such as a polygon mirror, galvano mirror, and MEMS mirror, and is directed onto a scanned object surface such as a photoconductive drum via a scanning lens that has a distortion correcting effect for attaining light scanning on the scanned object surface at a constant speed to provide an image as a spot thereon. The spot on the photoconductive drum is scanned in a main scanning direction accompanied by the rotation of the polygon mirror, tilt of the galvano mirror, or tilt of the MEMS mirror. At this time, an electrostatic latent image is formed on the scanned object surface with the laser beam being ON/OFF modulated.

An optical system for the light scanning device is required to be low in cost. For this reason, in many cases, an optical element configured with two plastic lenses is employed as the scanning lens, and further an anti-reflecting coating is not formed on the scanning lens. Thus, in such a light scanning device, a portion of the laser beam that should ideally totally be transmitted through the scanning lens is reflected as ghost light on a lens surface of the scanning lens. Then, the ghost light reaches the scanned object surface to form a ghost image thereon, and it causes the image of less quality than that to be ideally formed.

So far, various kinds of measures against the ghost light have been proposed. For example, there is disclosed in Japanese Patent Provisional Publication No. HEI 07-230051 such a technique that a lens surface of a plastic lens included in a scanning optical system is decentered in an auxiliary scanning direction with respect to an optical axis of an image forming optical system to separate the ghost light from drawing light, and that another lens surface is decentered in the opposite direction to the auxiliary scanning direction to correct a curved scanned line caused by the aforementioned decentered lens surface. Further, in Japanese Patent Provisional Publication No. 2004-354734, there is disclosed such another technique that an effect of the ghost light is reduced by defining the shape of the fθ lens to make the ghost light diverging light. Most of conventional measures against such a ghost light problem including the techniques disclosed in the aforementioned publications takes a method in which the effect of the ghost light is reduced by making the ghost light dispersed.

In the meantime, when the light scanning device is incorporated into a device such as a laser printer, the scanning device is employed with a light path being bent by mirrors to meet requirements of the device into which the light scanning device is incorporated. In such a scanning optical system with the light path being bent by the mirrors, when the ghost light is widely dispersed as aforementioned, the ghost light might not be transmitted trough some of the lenses, and be reflected by a mirror or a metal part to reach the scanned object surface without being blocked by a light shielding plate.

### SUMMARY OF THE INVENTION

The present invention is advantageous in that there can be provided an improved light scanning device and an improved scanning optical system that are configured to certainly prevent ghost light from reaching a scanned object surface even when a light path is bent by mirrors.

According to an aspect of the present invention, there is provided a light scanning device, which includes: a light source configured to emit a laser beam; a deflector configured to deflect and scan the laser beam emitted from the light source in a main scanning direction; and an image forming optical system configured to converge the light beam deflected by the deflector as a spot scanning in the main scanning direction on a scanned object surface. The image forming optical system is configured such that at least part of ghost light caused inside the image forming optical system is converged within a predetermined range in the main scanning direction regardless of an incident angle with which the laser beam deflected by the deflector is incident on the image forming optical system, and that the at least part of ghost light is separated from drawing light for forming an image in an auxiliary scanning direction which is perpendicular to the main scanning direction.

Optionally, the light scanning device may further include a light shielding element configured to block the at least part of ghost light.

Optionally, the image forming optical system may include a first lens arranged the closest to the deflector among optical elements included in the image forming optical system. Further optionally, the image forming optical system may be configured such that the at least part of ghost light caused by reflections of the incident laser beam between both lens surfaces of the first lens is converged within the predetermined range in the main scanning direction regardless of an incident angle with which the laser beam deflected by the deflector is incident onto the first lens.

Yet optionally, the first lens may be configured to satisfy a condition (1) shown below:
2(d₀+d₁)/f>1−d₀×(1−3n)(1/r₁−(1+d₁/(d₀n))/r₂) (1),
where d₀ represents a distance from a deflection point as an intersection of the laser beam with the deflector, defined when the image is formed in a position on the line intersecting with an optical axis along the auxiliary scanning direction on tile scanned object surface, to the first lens on the optical axis, d₁ represents thickness of the first lens on the optical axis, f represents a focal length of the image forming optical system,
n represents a refractive index of the first lens, r₁ represents a paraxial curvature radius of a surface at a deflector side of the first lens in the main scanning direction, and r₂ represents a paraxial curvature radius of a surface at a scanned object surface side of tile first lens in tile main scanning direction.

Optionally, at least one surface of the first lens may be decentered in the auxiliary scanning, direction with respect to a standard surface defined as a trajectory of a center axis of the laser beam deflected by the deflector.

Still optionally, the lens surfaces at both of the deflector side and the scanned object surface side of the first lens may be decentered in opposite directions to one another along tile auxiliary scanning direction with respect to the standard plane, Optionally, the image forming optical system may include a second lens arranged closer to the scanned object surface than the first lens, an anamorphiic surface of the second lens being decentered in the same direction as the lens surface at the scanned object surface side of the first lens.

Optionally, the laser beam deflected by the deflector may be incident onto the first lens at a slant in the auxiliary scanning direction with respect to the optical axis of the image forming optical system by a predetermined angle.

According to another aspect of the present invention, there is provided a scanning optical system, which includes: a light source configured to emit a laser beam; a deflector configured to deflect and scan the laser beam emitted from the light source in a main scanning direction: and an image forming optical system configured to converge the light beam deflected by the deflector as a spot scanned in the main scanning direction on a scanned object surface. The image forming optical system is configured such that at least part of ghost light caused inside the image forming optical system is converged within a predetermined range in the main scanning direction regardless of an incident angle with which the laser beam deflected by the deflector is incident on the image forming optical system, and that the at least part of ghost light is separated from drawing light for forming an image in an auxiliary scanning direction which is perpendicular to the main scanning direction.

### BRIEF DESCRIPTION OF THE ACCOMPANYING DRAWINGS

FIG. 1 is a top view in a main scanning plane showing arrangements of optical elements included in a light scanning device (scanning optical system) according to an embodiment of the present invention.

FIG. 2 is an illustration of a portion of the light scanning device (scanning optical system) shown in FIG. 1 from a polygon mirror to a scanned object surface in an auxiliary scanning direction.

FIG. 3 is an illustration in the main scanning plane showing a light path of ghost light caused in a first scanning lens.

FIG. 4 is an illustration in the main scanning plane showing a refraction angle of the ghost light caused at a first surface of the first scanning lens.

FIG. 5 is an illustration in the main scanning plane showing a reflection angle of the ghost light caused at a second surface of the first scanning lens

FIG. 6 is an illustration in the main scanning plane showing a reflection angle of the ghost light caused at tie first surface of the first scanning lens.

FIG. 7 is an illustration in the main scanning plane showing a refraction angle of the ghost light caused at the second surface of the first scanning lens.

FIG. 8 is a graph showing a relationship between an image height of drawing light and a range of an image height of the ghost light according to the embodiment of the present invention.

FIG. 9 is an illustration in the auxiliary scanning direction showing an example of a light path being bent with mirrors in the embodiment according to the present invention.

FIG. 10 is an illustration in the auxiliary scanning direction showing arrangements of optical elements provided in a portion of a light scanning device (scanning optical system) from a polygon mirror to a scanned object surface according to a modification of the present invention.

### DETAILED DESCRIPTION OF THE EMBODIMENTS

Hereinafter, embodiments of a light scanning device (scanning optical system) according to the present invention will be explained with reference to the accompanying drawings.

A light scanning device in an embodiment, which is used as a laser scanning unit (LSU) of the laser printer, is configured to scan a laser beam that is ON/OFF modulated in accordance with an inputted drawing signal on a scanned object surface such as a photoconductive drum and form an electrostatic latent image. In this specification, a direction in which a spot is scanned on tile scanned object surface is defined as a main scanning direction, and a direction perpendicular to the main scanning direction is defined as an auxiliary scanning direction. In addition, explanations about directions of a shape and power of each optical element will be made based on the directions on the scanned object surface. A plane that is parallel to the main scanning direction and includes an optical axis of an image forming optical system is defined as a main scanning plane. A plane defined as a trajectory of a center axis of the laser beam deflected by a deflector is regarded as a standard plane.

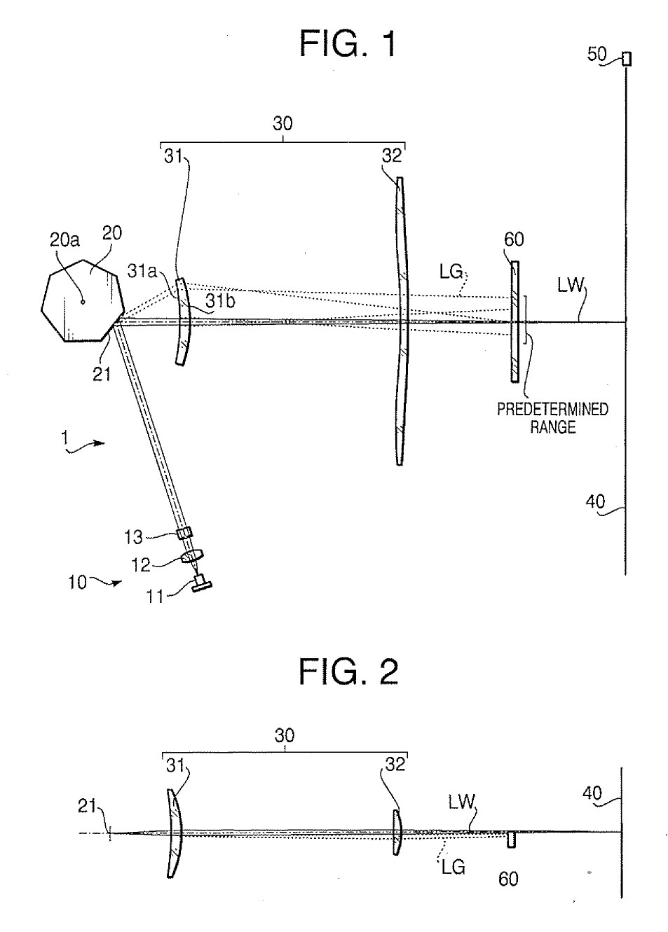

As shown in FIG. 1 that is a top view in the main scanning plane, a light scanning device (scanning optical system) 1 in the embodiment is configured such that a laser beam emitted from a light source 10 is reflected and deflected by a polygon mirror 20 as the deflector, and is then converged as a spot on a scanned object surface 40 with an fθ lens 30 as an image forming optical system.

The light source 30 is provided with a semiconductor laser 11, collimating lens 12 that makes a diverging laser beam emitted from the semiconductor laser 11 collimated, and cylindrical lens 13 having a positive power in the auxiliary scanning direction. Further, the light source 10 is configured such that the laser beam modulated in accordance with the drawing signal is incident onto the polygon mirror 20 from the outside of a scanning range of the laser beam by the polygon mirror 20. It is noted that, as substitute for the cylindrical lens 13, an anamorphic lens that has a positive power in the auxiliary scanning direction and a lower power in the main scanning direction than that in the auxiliary scanning direction can be employed.

The polygon mirror 20 has seven reflecting surfaces 21, and is configured rotatable in the clockwise direction in FIG. 1 around a rotation axis 20a perpendicular to the main scanning plane. The fθ lens 30 is provided with a first scanning lens 31 arranged in the vicinity of the polygon mirror 20 and a second scanning lens 32 arranged at the side of the scanned object surface 40. Both of the first and second scanning lenses are plastic lenses. A lens surface at the polygon mirror 20 side of the first scanning lens is defined as a first surface 31a, and a lens surface at the scanned object surface 40 side is defined as a second surface 31b.

The laser beam that has been emitted from the semiconductor laser 11 and collimated by the collimating lens 12 forms a line image in the vicinity of the polygon mirror 20 via the cylindrical lens 13.

The laser beam reflected by the polygon mirror 20 is incident onto the fθ lens 30 as a laser beam substantially collimated in the main scanning direction as indicated by solid lines in FIG. 1 and diverging in the auxiliary scanning direction as indicated by solid lines in FIG. 2. A proper drawing light LW transmitted through the fθ lens 30 forms a spot on the scanned object surface 40. The spot is scanned on the scanned object surface 40 in the main scanning direction accompanied by the rotation of the polygon mirror 20. At this time, the scanned line is formed with the semiconductor laser 11 being modulated.

It is noted that there is provided short of a starting end of the scanned object surface 40 in the main scanning direction a light detecting sensor 50 for obtaining a synchronizing signal for modulation.

The aforementioned light scanning device (scanning optical system) 1 is configured such that, regardless of an angle of the ghost light LG incident onto the first scanning lens 31, ghost light LG generated between the first surface 31a and second surface 31b is converged within a predetermined range in the main scanning direction (see FIG. 1), and is separated from the drawing light LW in the auxiliary scanning direction (see FIG. 2). Further, there is provided between the second scanning lens 32 and the scanned object surface 40 a light shielding plate 60 as a light shielding means for blocking the ghost light. The light shielding plate 60 is located at a center portion of the scanning range in the main scanning direction as shown in FIG. 1 and at a position shifted from the optical axis in the auxiliary scanning direction as shown in FIG. 2.

In order to concentrate the ghost light LG within the predetermined range in the main scanning direction, the first scanning lens 31 is configured to satisfy the following condition (1):
2(d₀+d₁)/f>−1−d₀×(1−3n)(1/r−(1+d₁/(d₀n))/r₂) (1)
where d₀ represents a distance from a deflection point (intersection of the incident laser beam with each of the reflecting surfaces 21) to the first scanning lens 31 on the optical axis, d₁ represents thickness of the first scanning lens 31 on the optical axis, f represents a focal length of the image forming optical system, n represents a refractive index of tie first scanning lens 31, r₁ represents a paraxial curvature radius of the first surface 31a of the first scanning lens 31, and r₂ represents a paraxial curvature radius of the second surface 31b of the first scanning lens 31.

Further, in order to separate the ghost light from the drawing light in the auxiliary scanning direction, the first surface 31a of the first scanning lens 31 is decentered in the auxiliary scanning direction with respect to the standard plane. In addition, to correct a curved scanned line caused by the decentered first surface 31a, the second surface 31b is decentered in an opposite direction to the auxiliary with respect to the standard plane. It is noted that, when the lens surfaces are decentered, besides decentering both of the lens surfaces of the first scanning lens 31 in the opposite directions to one another as aforementioned, only one of the lens surfaces of the first scanning lens 31 may be decentered with respect to the standard plane. In addition, an anamorphic surface (in the embodiment, a lens surface at the scanned object surface 40 side) of the second scanning lens may be decentered in the same direction as the second surface 31b with both of the lens surfaces 31a and 31b of the first scanning lens 31 being decentered in the opposite directions to one another.

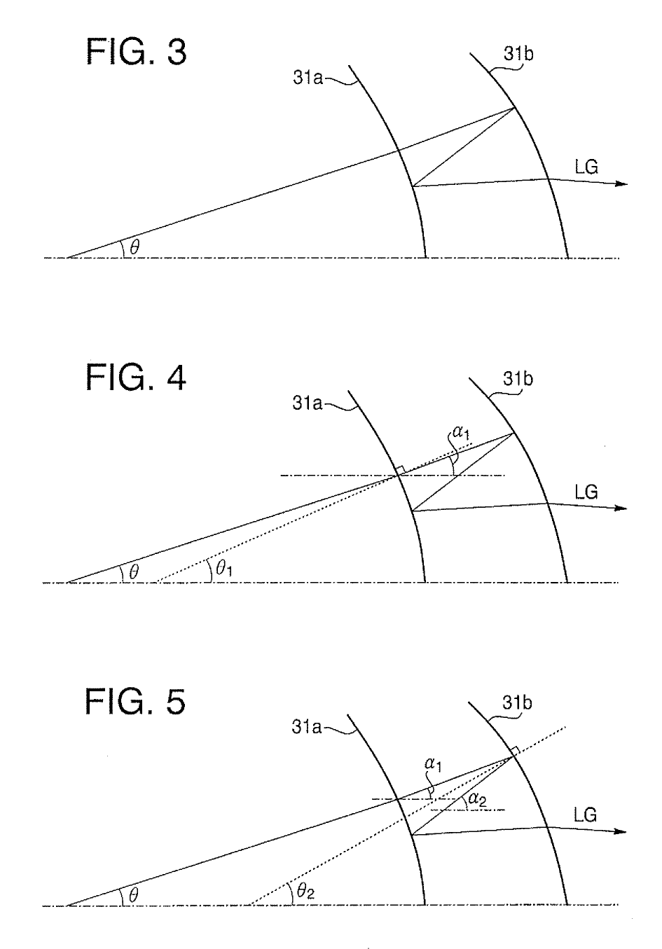

Next, it will be explained how the aforementioned condition (1) is derived, based on FIGS. 3-7. FIG. 3 shows a light path of the ghost light that is reflected by the second surface 31b and the first surface 31a of the first scanning lens 31 in sequence. In FIG. 3, a solid line LG represents the ghost light, and an alternate long and short dash line denotes the optical axis of the fθ lens 30. It is noted that alternate long and short dash lines other than the optical axis shown in FIGS. 4 to 7 are linear lines parallel to the optical axis.

The laser beam reflected by the polygon mirror 20 with a deflection angle θ, as shown in FIG. 4, is refracted by the first surface 31a, and goes toward the second surface 31b inside the first scanning lens 31. When a perpendicular line as indicated by a dashed line in FIG. 4 is dropped to an intersection of the ray with the first surface 31a and an angle between the perpendicular line and the optical axis is represented as θ₁, an angle α₁ between the refracted ray and the optical axis is expressed by the following equation (2):
α₁≅((n−1)θ₁+θ)/n (2)

Generally, in order to improve an optical performance, a scanning lens system such as tile fθ lens 30 is configured such that a surface at a scanned object surface side of a first scanning lens has most of a power of the first scanning lens. Namely, curvature of a surface at a deflector side of the first scanning lens is generally small, and consequently, the θ₁ is relatively small. In addition, since the laser beam has a width in the main scanning direction and an incident height of the laser beam varies with a change of the deflection point, even though the angle θ₁ is small, a portion of the laser beam is incident onto the first surface 31a with a higher incident height. In view of such situations, the aforementioned equation (2) can be approximated as follows:
α₁≅θ/n

In the laser beam that has reached the second surface 31b, a transmitted component acts as proper drawing light, while a reflected component acts as ghost light. As shown in FIG. 5, when a perpendicular line as indicated by a dashed line is dropped to an intersection of the ray with the second surface 31b and an angle between the perpendicular line and the optical axis is defined as θ₂, an angle α₂ between the ray reflected by the second surface 31b and optical axis is expressed by the following equation (3):
α₂≅2θ₂−α₁ (3)

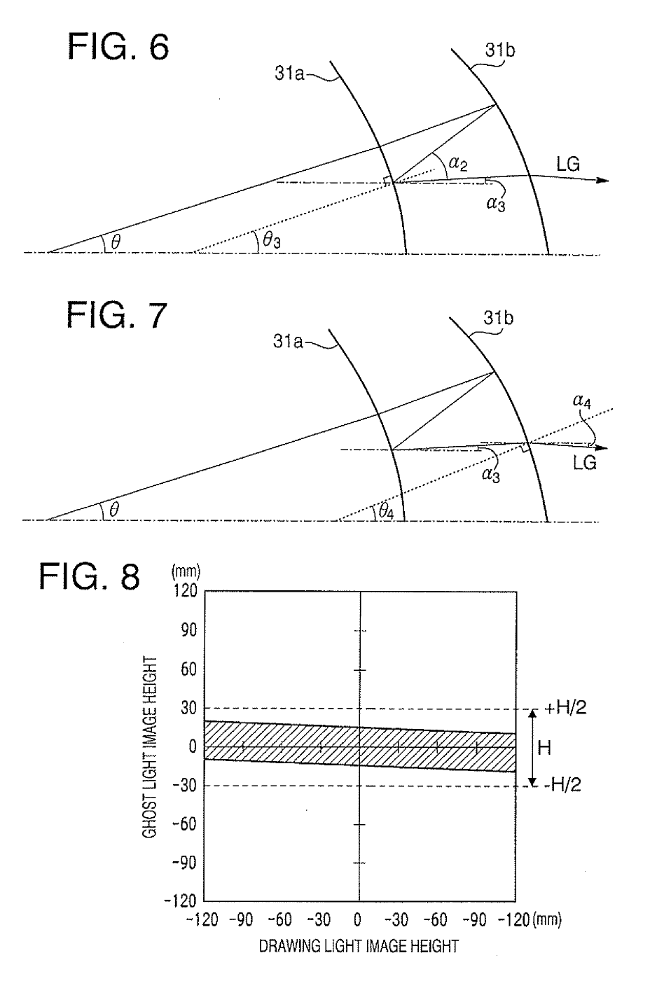

Then, the ghost light is reflected again by the first surface 31a and directed to the second surface 31b. As shown in FIG. 6, when a perpendicular line as indicated by a dashed line is dropped to an intersection of the ray with tile first surface 31a and an angle between the perpendicular line and the optical axis is defined as θ₃, an angle α₃ between the ray reflected by the first surface 31a and the optical axis is expressed by the following equation (4):
α₃≅2θ₃−α₂ (4)

The ghost light that has reached the second surface 31b again is transmitted through the second surface 31b and directed to the scanned object surface 40. As shown in FIG. 7, when a perpendicular line as indicated by a dashed line is dropped to an intersection of tile ray with the second surface 31b and an angle between the perpendicular line and the optical axis is defined as θ₄, an angle α₄ between the ray refracted by the second surface 31b and the optical axis is expressed by the following equation (5):
α₄≅(1−n)θ₄+nα₃ (5)

Using the aforementioned equations (2) to (5), the following equation (6) can be derived:
α₄=θ−(1−n)θ₁+2nθ₃−2nθ₂+(1−n)θ₄
α₄/θ−1+(−(1−n)θ₁+2nθ₃−2nθ₂+(1−n)θ₄)/θ (6)

Here, when the height of a position to which the laser beam deflected with a deflection angle θ is incident on the first surface 31a from the optical axis is represented by h₁, the following equations (7) and (8) are obtained:
θ≅h₁/d₀ (7)
θ₁≅−h₁/r₁ (8)
Then, a height h2 of an intersection of the ray deflected by the first surface 31a with the second surface 31b from the optical axis is expressed by the following equation (9) using the aforementioned equation α₁≅θ/n. Further, the angle θ₂ of the perpendicular line with respect to the optical axis is represented by an equation (10) using the equation (9).
h₂=h₁+d₁θ/n=h₁+(d₁h₁)/(d₀n) (9)
θ₂=−h₂/r₂=h₁/r₂(d₁/d₀n) (10)

When it is supposed that the following relationships θ₁≅θ₃ and θ₂≅θ₄ can be established in the aforementioned equation (6), an equation (11) shown below can be obtained using the equations (7), (8), and (10).
α₄/θ=1+d₀(1−3n)(1 /r₁−(1+d₂/(d₀n))/r₂)
(11)

In the meantime, when a maximum deflection angle is represented by θ, a scanning length is fθ, and an effective diameter (total width of the lens) HE of the first scanning lens 31 is expressed as H≅2(d₁+d₂)θ. Therefore, by dividing the effective diameter H by the scanning length, the following equation (12) is obtained:
H/fθ=2(d₁+d₂)/f (12)

Here, when it is supposed that a maximum image height fα₄ is equal to the effective diameter H, the equation (12) is transformed to the following equation (13) based on α₄<0. When the following condition (14) is satisfied, the image height of the ghost light can be suppressed within the diameter of the first scanning lens.
α₄/θ=−2(d₁+d₂)/f (13)
α₄/θ<−2(d₁ +d₂)/f (14)

By replacing the left part of the condition (14) with the equation (11), the condition (1) can be derived. Namely, with the condition (1) being satisfied, the maximum image height of the ghost light is made smaller than the diameter of the first scanning lens to be converged within the predetermined range in the main scanning direction without the ghost light being allowed to be diverging light.

Next, a concrete configuration of the light scanning device (scanning optical system) 1 in the embodiment will be explained. In the embodiment, the first surface 31a of the first scanning lens 31 is a concave spherical surface, and the second surface 31b is a convex aspheric surface of rotational symmetry. In addition, a surface of the second scanning lens 32 at the polygon mirror 20 side is a concave aspheric surface of rotational symmetry, and a surface thereof at the scanned object surface 40 side is an anamorphic aspheric surface.

The shape of the aspheric surface of rotational symmetry is represented by a sag amount X(h) from a tangent plane at an intersection of the optical axis with the aspheric surface at a distance “h” from the optical axis. The sag amount X(h) is expressed by the following equation;

$$X ( h ) = \frac{{h}^{2}}{r \{ 1 + \sqrt{( 1 - ( κ + 1 ) {h}^{2} / {r}^{2}} \}} + {A}_{4} {h}^{4} + {A}_{6} {h}^{6}$$

In the above equation, r represents a curvature radius on the optical axis, κ represents a conical coefficient, and A4 and A6 represent fourth and sixth order aspheric coefficients, respectively.

In addition, the anamorphic aspheric surface is an aspheric surface without a rotation axis, of which a curvature radius in the auxiliary scanning direction at a position off the optical axis is configured independently of a cross-sectional shape of the aspheric surface in the main scanning direction. When the curvature radius on the optical axis in the main scanning direction is represented by “ry₀”, the conical coefficient is represented by “κ”, an n-th order aspheric coefficient in the main scanning direction is represented by “AMₙ”, a curvature radius on the optical axis in the auxiliary scanning direction at each position y in the main scanning direction is represented by “rz₀”, and an n-th order aspheric coefficient in the auxiliary scanning direction is represented by “ASₙ”. The cross-sectional shape X(y) in the main scanning direction and the curvature radius rz(y) in the auxiliary scanning direction can be obtained from the following equations, respectively:

$$X ( y ) = \frac{{y}^{2}}{{ry}_{0} ( 1 + \sqrt{1 - \frac{( κ + 1 ) {y}^{2}}{{ry}_{0}^{2}}} )} + {\sum }_{i = 4}^{8} {AM}_{i} \cdot {y}^{i}$$

$$\frac{1}{rz ( y )} = \frac{1}{{rz}_{0}} + {\sum }_{i = 1}^{8} {AS}_{i} \cdot {y}^{i}$$

A concrete numerical specification of the light scanning device (scanning optical system) in the embodiment is shown in Table 1. In Table 1, a reference sign “ry” represents the curvature radius (unit: mm) of each optical element in the main scanning direction, a reference sign “rz” represents the curvature radius in the auxiliary scanning direction (which is omitted in case of a surface of rotational symmetry, unit: mm), a reference sign “d” represents the distance between surfaces on the optical axis (unit: mm), and a reference sign “nλ” represents the refractive index at a design wavelength. In this example, the design wavelength is 780 nm.

TABLE 1
Polygon mirror inscribed radius R = 15.14 mm
Number of polygon surfaces: 7, Design wavelength: 780 nm

| Surface | | | | | |
|---|---|---|---|---|---|
| Number | ry | rz | d | nλ | Optical Element |
| 1 | ∞ | 51.08 | 4.00 | 1.51072 | Cylindrical Lens |
| 2 | ∞ | — | 97.00 | | |
| 3 | ∞ | — | 24.00 | | Polygon Mirror |
| 4 | −65.20 | — | 6.40 | 1.48617 | First Scanning |
| 5 | −40.00 | — | 104.00 | | Lens |
| 6 | −400.00 | — | 3.20 | 1.48617 | Second Scanning |
| 7 | −1600.00 | −27.52 | 106.60 | | Lens |
| 8 | ∞ | — | — | | Scanned Object |
| | | | | | Surface |

Values of the conical coefficients and aspheric coefficients that define aspheric surfaces of rotational symmetry indicated by the surface numbers “5” and “6” are shown in Tables 2 and 3, respectively. Values of the conical coefficient and aspheric coefficient that define an anamorphic aspheric surface for the seventh surface are shown in Tables 4.

TABLE 2
Aspheric surface of rotational symmetry (Surface Number 5)

| | |
|---|---|
| κ | 0.00000 |
| A₄ | 4.88072 × 10⁻⁰⁷ |
| A₆ | 0.00000 |

TABLE 3
Aspheric surface of rotational symmetry (Surface Number 6)

| | |
|---|---|
| κ | 0.00000 |
| A₄ | 1.98405 × 10⁻⁰⁸ |
| A₆ | 0.00000 |

TABLE 4
Anamorphic aspheric surface (Surface Number 7)

| κ | 0.0000 | | |
|---|---|---|---|
| AM₁ | 0.0000 | AS₁ | 2.4150 × 10⁻⁰⁶ |
| AM₂ | 0.0000 | AS₂ | 2.5935 × 10⁻⁰⁶ |
| AM₃ | 0.0000 | AS₃ | −8.6023 × 10⁻¹⁰ |
| AM₄ | 5.5205 × 10⁻⁰⁸ | AS₄ | −2.7362 × 10⁻¹⁰ |
| AM₅ | 0.0000 | AS₅ | 1.3616 × 10⁻¹⁰ |
| AM₆ | −7.0565 × 10⁻¹² | AS₁₀ | 0.0000 |
| AM₇ | 0.0000 | AS₁₂ | 0.0000 |
| AM₈ | −8.3631 × 10⁻¹⁶ | AS₁₄ | 0.0000 |

According to the above configuration, the left and right parts of the condition are calculated as follows, respectively:
2(d₀−d₁)/f≅0.249
−1−d₀×(1−3n)(1/r₁−(1+d₁/(d₀n))/r₂)≅0.147
Accordingly, the condition (1) is satisfied,

FIG. 8 is a graph showing a relationship between the image height of the spot formed on the scanned object surface 40 by the proper drawing light in the main scanning direction and a range of the image height, in the main scanning direction, of the ghost light that reaches the scanned object surface 40 in the case without the light shielding plate 60 at that time. As shown in FIG. 8, even though the image height of the drawing light, that is, the deflection angle θ is changed, the image height of the ghost light is concentrated in a center range including the center of the scanning range, and the maximum value and minimum value of the image height of the ghost light are within a range (−H/2˜+H/2) of the effective diameter H of the first scanning lens 31. This means that it is possible to block the ghost light with a small light shielding plate as wide as the effective diameter H.

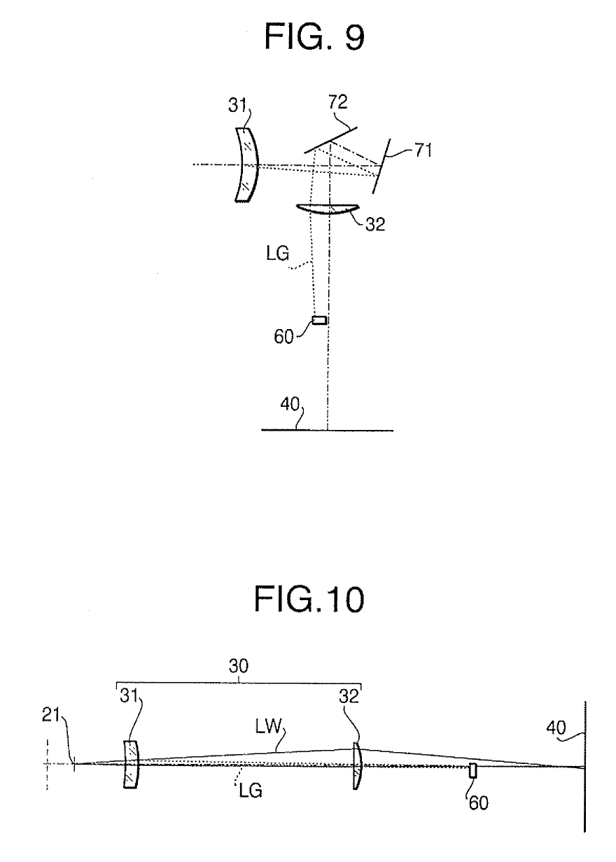

It is noted that the light path of the light scanning device (scanning optical system}) is generally bent with mirrors. FIG. 9 is an illustration in the auxiliary scanning direction showing an example of the light path being bent. According to the configuration shown in FIG. 9, the beam transmitted through the first scanning lens 31 is perpendicularly bent with a first mirror 71 and a second mirror 72, and incident onto the second scanning) lens 32. The optical axis is indicated by an alternate long and short dash line, while the ghost light LG follows a light path indicated by a dashed line, and is blocked by the light shielding plate 60. As the ghost light is converged within a predetermined range, even when using the mirrors as shown in FIG. 9, the ghost light is transmitted through the lens as well as the drawing light, and is not reflected by the mirrors without being transmitted through the lens.

There may be possible as a method of separating the ghost light from the drawing light in the auxiliary scanning direction a method in which the laser beam emitted from the light source is made incident onto the polygon mirror with an angle in the auxiliary scanning direction without the lens surface being decentered in the auxiliary scanning direction as aforementioned. For example, in a multi-beam LSU configured to simultaneously scan a plurality of laser beams with a single polygon mirror, the plurality of laser beams are made incident onto the polygon mirror with different angles in the auxiliary scanning directions, respectively.

FIG. 10 is an illustration in the auxiliary scanning direction showing arrangements of optical elements closer to the scanned object surface 40 than the polygon mirror 20 in a light scanning device (scanning optical system) 1, which is a modification of the aforementioned embodiment, employed as the multi-beam LSU. In FIG. 10, only one laser beam is shown among the plurality of laser beams. The laser beam incident onto a reflecting surface 21 of the polygon mirror 20 with an angle in the auxiliary scanning direction is incident at a slant onto the first scanning lens 31 of the fθ lens 30. Then, the proper drawing light LW is transmitted through a far portion of the second scanning lens 32 from the optical axis to reach the scanned object surface 40. The ghost light LG reflected inside the first scanning lens 31 is transmitted through a close portion of the second scanning lens 32 to the optical axis, and is blocked by the light shielding plate 60. Therefore, the ghost light LG cannot reach the scanned object surface 40.

In FIG. 10, the light path is drawn as being straight. However, in general, the light path is bent with mirrors in a similar manner to the example shown in FIG. 9. In a light scanning device (scanning optical system) configured based on a tandem system (a system having a plurality of photoconductive drums) used for a color printer and the like, a plurality of laser beams, which travel with angle differences with respect to each other, use the polygon mirror 20 and the first scanning lens 31 in common, and are separated with a mirror to be converged on the respective photoconductive drums (scanned object surfaces) via respective second scanning lenses provided on respective light paths. Even in such a case, a light shielding plate provided between the second scanning lens and scanned object surface on each of the light paths can prevent the ghost light from reaching the scanned object surface.

The present disclosure relates to the subject matters contained in Japanese Patent Applications No. P2005-304704 and No. P2005-340873, filed on Oct. 19, 2005, and Nov. 25, 2005, respectively, which are expressly incorporated herein by reference in their entirety.

What is claimed is:

1. A light scanning device, comprising:
a light source configured to emit a laser beam;
a deflector configured to deflect and scan the laser beam emitted from the light source in a main scanning direction; and
an image forming optical system configured to converge the light beam deflected by the deflector as a spot scanning in the main scanning direction on a scanned object surface,
wherein the image forming optical system is configured such that at least part of ghost light caused inside the image forming optical system is converged within a predetermined range in the main scanning direction regardless of an incident angle with which the laser beam deflected by the deflector is incident on the image forming optical system, and that the at least part of ghost light is separated from drawing light for forming an image in an auxiliary scanning direction which is perpendicular to the main scanning direction.

2. The light scanning device according to claim 1, further comprising a light shielding element configured to block the at least part of ghost light.

3. The light scanning device according to claim 1,
wherein the image forming optical system includes a first lens arranged the closest to the deflector among optical elements included in the image forming optical system, and
wherein the image forming optical system is configured such that the at least part of ghost light caused by reflections of the incident laser beam between both lens surfaces of the first lens is converged within the predetermined range in the main scanning direction regardless of an incident angle with which the laser beam deflected by the deflector is incident onto the first lens.

4. The light scanning device according to claim 3,
wherein the first lens is configured to satisfy a condition (1) shown below:
2(d₀+d₁)/f>−1−d₀×(1−3n)(1/r₁−(1+d₁/(d₀n)/r₂) (1),
where d₀ represents a distance from a deflection point as an intersection of the laser beam with the deflector, defined when the image is formed in a position on the line intersecting with an optical axis along the auxiliary scanning direction on the scanned object surface to the first lens on the optical axis,
d₁ represents thickness of the first lens on the optical axis,
f represents a focal length of the image forming optical system,
n represents a refractive index of the first lens,
r₁ represents a paraxial curvature radius of a surface at a deflector side of the first lens in the main scanning direction, and
r₂ represents a paraxial curvature radius of a surface at a scanned object surface side of the first lens in the main scanning direction.

5. The light scanning device according to claim 3,
wherein at least one surface of the first lens is decentered in the auxiliary scanning direction with respect to a standard surface defined as a trajectory of a center axis of the laser beam deflected by the deflector.

6. The light scanning device according to claim 5,
wherein the lens surfaces at both of the deflector side and the scanned object surface side of the first lens are decentered in opposite directions to one another along the auxiliary scanning direction with respect to the standard plane, and
wherein the image forming optical system includes a second lens arranged closer to the scanned object surface than the first lens, an anamorphic surface of the second lens being decentered in the same direction as the lens surface at the scanned object surface side of the first lens.

7. The light scanning device according to claim 3,
wherein the laser beam deflected by tile deflector is incident onto the first lens at a slant in the auxiliary scanning direction with respect to the optical axis of the image forming optical system by a predetermined angle.

8. A scanning optical system, comprising:
a light source configured to emit a laser beam;
a deflector configured to deflect and scan the laser beam emitted from the light source in a main scanning direction; and
an image forming optical system configured to converge the light beam deflected by the deflector as a spot scanning in the main scanning direction on a scanned object surface,
wherein the image forming optical system is configured such that at least part of ghost light caused inside the image forming optical system is converged within a predetermined range in the main scanning direction regardless of an incident angle with which the laser beam deflected by the deflector is incident on the image forming optical systems and that the at least part of ghost light is separated from drawing light for forming an image in an auxiliary scanning direction which is perpendicular to the main scanning direction.

9. The scanning optical system according to claim 8, further comprising a light shielding element configured to block the at least part of ghost light.

10. The scanning optical system according to claim 8,
wherein the image forming optical system includes a first lens arranged the closest to the deflector among optical elements included in the image forming optical system, and
wherein the image forming optical system is configured such that the at least part of ghost light caused by reflections of the incident laser beam between both lens surfaces of the first lens is conveyed within the predetermined range in the main scanning direction regardless of an incident angle with which the laser beam deflected by the deflector is incident onto the first lens.

11. The scanning optical system according to claim 10,
wherein the first lens is configured to satisfy a condition (1) shown below:
2(d₀+d₁)/f>−1−d₀×(1−3n)(1/r₁−(1+d₁/(d₀n)/r₂) (1),
where d₀ represents a distance from a deflection point as an intersection of the laser beam with the deflector, defined when the image is formed in a position on the line intersecting with an optical axis along the auxiliary scanning direction on the scanned object surface, to the first lens on the optical axis,
d₁ represents thickness of the first lens on the optical axis,
f represents a focal length of the image forming optical system,
n represents a refractive index of the first lens,
r₁ represents a paraxial curvature radius of a surface at a deflector side of the first lens in the main scanning direction, and
r₂ represents a paraxial curvature radius of a surface at a scanned object surface side of the first lens in the main scanning direction.

12. The scanning optical system according to claim 10,
wherein at least one surface of the first lens is decentered in the auxiliary scanning direction with respect to a standard surface defined as a trajectory of a center axis of the laser beam deflected by the deflector.

13. The scanning optical system according to claim 12,
wherein the lens surfaces at both of the deflector side and the scanned object surface side of the first lens are decentered in opposite directions to one another along the auxiliary scanning direction with respect to the standard plane, and
wherein the image forming optical system includes a second lens arranged closer to the scanned object surface than the first lens, an anamorphic surface of the second lens being decentered in the same direction as the lens surface at the scanned object surface side of the first lens.

14. The scanning optical system according to claim 10,
wherein the laser beam deflected by the deflector is incident onto the first lens at a slant in the auxiliary scanning direction with respect to the optical axis of the image forming optical system by a predetermined angle.
